(19) United States
(12) Patent Application Publication
(10) Pub. No.: US 2018/0290474 A1
(43) Pub. Date: Oct. 11, 2018

(54) UNPRINTING CARTRIDGE

(71) Applicant: REEP TECHNOLOGIES LTD., Kochav Yair (IL)

(72) Inventors: Anthony DUNN, Cambridge (GB); David LEAL-AYALA, Cambridge (GB)

(21) Appl. No.: 15/557,842

(22) PCT Filed: Mar. 11, 2016
(86) PCT No.: PCT/GB2016/050663

§ 371 Date: Sep. 13, 2017

(30) Foreign Application Priority Data
Mar. 13, 2015 (GB) 1504272.4

(51) Int. Cl. B41M 7/00; B41J 29/377

(52) U.S. Cl. CPC B41M 7/0009; B41J 29/377

(57) ABSTRACT

We describe a print removal system for removing print from a print-carrying medium, the print removal system comprising one or more slots for receiving one or more cartridges configured to collect removed print debris.

### FIELD OF THE INVENTION

This invention relates to a print removal system configured to remove print, such as toner ink, from a print-carrying medium, whereby the system has slots for receiving print debris collection and filter units.

### BACKGROUND TO THE INVENTION

We have previously described a combination of laser pulse length and wavelength which optimises the removal of toner ink from white paper, in Leal-Ayala D. R. and Allwood J. M., “Paper re-use: Toner-print removal by laser ablation”, International Conference on Digital Printing Technologies (2010), pages 6-9; and also in Leal-Ayala, D. R., Allwood, J. M., Schmidt, M., & Alexeev, I. (2012), “Toner-print removal from paper by long and ultrashort pulsed lasers”, Proceedings of the Royal Society A: Mathematical, Physical and Engineering Science, 468(2144), 2272-2293. FIG. 1, which is taken from the Proc. Roy. Soc. paper, illustrates the relationship between wavelength, pulse length and paper damage, showing that the optimum wavelength is in the visible, around the green, and that the optimum pulse length is in the range 1-40 ns. Further background prior art can be found in U.S. Pat. No. 8,693,064; U.S. Pat. No. 5,489,158; US2004/0080787; US2012/0268799; and WO95/00343; JP2005/292747A also appears to describe a paper sheet regenerating device.

We have previously described in our pending GB patent application 1423033.8 how to solve various practical engineering problems in order to make a practical, commercial print removal system (“unprinter”). Broadly speaking, an “unprinter” is a system or apparatus which comprises a laser device in combination with a positioning sensor to effectively remove (i.e. “unprint”) toner print from an item of media (e.g. paper). Toner particles are removed from paper by laser ablation. The “unprinter” system and the process to “unprint” toner print are described in more detail in GB patent application 1423033.8, which is incorporated herein by reference in its entirety.

However, there is a need for further improvements of such print removal systems.

### SUMMARY OF THE INVENTION

We have described, in the GB patent application filed by the same applicant on the same day as this application, such an improved print removal system. Thus we have previously described a print removal device for removing print from a print-carrying medium, the print removal device comprising: a laser light source for providing a controllable laser light beam; and a controllable reflector for reflecting said laser light beam onto said print-carrying medium to remove said print from said print-carrying medium.

The inventors have realised that by providing a reflector in the print removal device, it is no longer necessary to provide a print removal head comprising a laser light source, in which a lateral position of the print removal head is controlled to move the laser light source over the print-carrying medium. Instead, the laser light beam is provided by a laser light source which may be fixed in the print removal device. A position of laser light beam impinging on the print-carrying medium may be varied by controlling the reflector. Since in these devices there is no need for controlling a position of the laser light source, a complex control system for controlling the laser light source is made redundant. By intersecting the laser light beam, the beam may be reflected by the reflector towards the print-carrying medium.

Furthermore, since moving the position of a heavy laser light source would result in high power consumption, the power consumption of the print removal device is advantageously reduced.

Further still, moving a heavy laser light source may be relatively slow. Therefore, by providing a reflector whose position and/or tilt may be varied, whereby the reflector is relatively light compared to a laser light source, the “unprinting” process may be performed at a higher rate.

A further advantage of exploiting a reflector, which may be controlled as will be further outlined below, is that the reflector (or where a carrier for the reflector is used, the carrier) may be close to the print-carrying medium, thereby reducing the size of the print removal device. By comparison, a laser light source on a carrier would increase the volume of the print removal device above the print-carrying medium significantly. It is noted that references to print throughout the description comprise, for example, toner, ink, pen marks, pencil marks or any other kind of print/mark/writing/image on the print-carrying medium which is known to those skilled in the art.

One or more baffles may be provided in the print removal device so as to protect the reflector, and/or the laser light source, and/or other devices of the print removal device, in particular optical devices, from dust or print removed with the laser light beam.

The laser light source is connected to a power supply.

We have further described a preferred print removal device which comprises a print sensor for sensing a position of the print on the print-carrying medium, wherein the controllable reflector is configured to reflect the laser light beam onto the print-carrying medium to remove the print from the print-carrying medium in response to said sensing.

The resolution of the print sensor is between 300 dpi and 600 dpi.

The total time for “unprinting” a print-carrying medium may thereby be reduced by not scanning, with the laser light beam, areas that do not need to be “unprinted”.

We have further described a preferred print removal device, whereby controlling of the controllable reflector comprises one or both of: controlling a position of the reflector in a first direction having a component which is perpendicular to a direction of movement of the print-carrying medium in the print removal device, wherein the first direction is substantially parallel to a plane of the print-carrying medium; and rotating the reflector for varying a second direction of the reflected laser light beam.

Rotating the reflector is to be interpreted as to any change of orientation of the reflector which results in the laser light beam being reflected in a different direction. The reflector may be rotated continuously or it may be rotated back and forth.

The controllable reflector may be driven over the print-carrying medium in a direction which is substantially perpendicular to a direction of movement of the print-carrying medium in the print removal device. Preferably, the reflector is moved from side to side covering the entire width of the print-carrying medium. Alternatively or additionally, the reflector may be rotated or tilted such that the laser light beam may be reflected into a different direction to allow different areas of the print-carrying medium to be exposed to the laser light beam. Whenever reference is made in this description to rotating the reflector, this also refers to tilting the reflector, and more generally to any change in the direction of an axis, in particular the normal axis, of the reflector to reflect the laser light beam into a different direction.

The reflector may be controlled with a motor, in particular a DC motor, which may have a position/speed feedback encoder. The motor may be integrated in the print removal device (with or without control system), or an external linkage may be provided to drive the transport, for example linked via a belt, shaft or gears. The reflector may, preferably, accelerate or decelerate at acceleration/deceleration regions at each end of a carrier. An elongated bearing may be provided on the carrier to minimize rotation and to provide a stable, vibration-free operation of the carrier/reflector. Cooling vanes may further be provided on the carrier. A position and/or tilt of the reflector may be controlled using a projection riding on a rail.

The reflector may be mounted on a controllable carrier. The reflector may be integral to the controllable carrier.

Preferably, the carrier may be a low-mass carrier which may allow for a reduction in power consumption when controlling a position and/or tilt of the carrier, and therefore the reflector. Using a low-mass reflector and, where employed, a low-mass carrier allows for quick movement of these components with little inertia and low power consumption.

The carrier of the reflector may be as close to the drive point as possible to prevent rotational torque when accelerating and decelerating the carrier. A counterweight may be integrated into the carrier to balance the load of the reflector and its mount. The close packing may allow for the overall mass (including that of the counterweight) to be reduced.

The reflector may be, for example, a mirror, a prism, or the like. Preferably, the reflector is of low cost and at the same time of high reflectance. For example, in some devices, the reflector may comprise a composite material comprising one or more of beryllium, aluminium and silica, and may be prepared as solid or as fused particles, preferably post-machined and with an evaporated reflective coating. The skilled person will be familiar with materials and processes for obtaining low-cost, high-reflective reflectors. A small reflector is preferable since the smaller the reflector, the faster it may be moved in the print removal device. It will be appreciated that the mirror is preferably at least as large as the laser spot size allowing the entire laser beam to be reflected.

We have further described a preferred print removal device, whereby controlling and/or rotating the reflector allow for two or more laser light beam-exposed regions of said print-carrying medium to overlap. An overlap of regions which may be exposed to the laser light beam may allow for providing a full coverage of the print-carrying medium. The overlap may be varied such that any given area or location of the print-carrying medium may be exposed once or multiple times.

In some print removal devices, the laser light beam has a circular spot shape. It has been found that in these devices, an optimum separation of adjacent laser light beam pulses (i.e. distance between centres of two neighbouring spots) for speed of “unprinting” an entire surface of a print-carrying medium is approximately 2^{-½} times the spot diameter for the circular spot. This means that where the quality and energy of the laser light beam spot are sufficient to “unprint” with a single exposure, the square fitted within the circular spots may be abutted, as will be further described below.

We have further described a preferred print removal device, whereby the reflected laser light beam impinges on the print-carrying medium substantially at a right angle. Therefore, preferably, the laser light beam has an optimal shape and a uniformity of power above a threshold (beam quality) such that it can be reflected through a right angle by a flat reflector, thereby maintaining the characteristics of the laser spot.

The reflector is thereby preferably disposed to move perpendicular to the direction of movement of the print-carrying medium through the “unprinting” area. The motion of the reflector is preferably parallel to an axis of the collimated, non-divergent laser light beam, thereby projecting the laser light beam onto the print-carrying medium surface to give substantially the same spot characteristics at all locations across the print-carrying medium as the reflector sweeps across it. In some preferred devices, the laser light beam is therefore provided by the laser light source in a direction which is substantially parallel to a plane of the print-carrying medium and substantially perpendicular to a direction of motion of the print-carrying medium in the print removal device. When using a substantially flat reflector, the angle of incidence of the laser light beam onto the reflector may be approximately 45 degrees so as to maintain the spot shape of the laser light beam when impinging on the print-carrying medium.

As outlined above, preferably, the laser light beam is round. The reflector may have a rectangular shape as it may need to be longer than the diameter of the laser light spot due to the angle of inclination. The reflector does not necessarily have to be rectangular as a rectangular reflector would have excess unused material in the other dimensions which need only be as wide as the laser light spot. This may advantageously reduce mass and cost of the reflector.

We have further described a preferred print removal device, whereby the reflected laser light beam has a shape which is longer in a fourth direction than in a fifth direction when impinging on said print-carrying medium, wherein the fourth direction is substantially parallel to a direction of movement of the print-carrying medium in the print removal device and wherein the fifth direction is substantially perpendicular to the direction of movement of the print-carrying medium in the print removal device.

An advantage of a laser light beam spot or line having a relatively long dimension in the axis of print-carrying medium movement is that the mechanical alignment is less demanding in order to allow abutting or overlapping of adjacent areas exposed by the laser light beam. For example, where the laser line length or spot width is large relative compared to mechanical tolerances, the positioning of the print-carrying medium within the print removal device may be tolerated to up to 0.1 mm, preferably up to 0.5 mm or even more preferably up to 10 mm.

A distortion of the laser light beam may be achieved in various ways. On the one hand, the reflector may be inclined at an angle (i.e. rotated as outlined above) to distort the laser light beam spot shape. Alternatively or additionally, the reflector is not flat, but may be convex, concaved, curved or may have another complex form to distort the laser light beam. For example, an approximately circular spot shape of the laser light beam impinging on the reflector may be converted into an elongated shape when reflected by the reflector, to thereby support a wide swath at the same time as concentrating energy into a narrow line-shaped beam.

It will be appreciated that when the reflector is tilted to direct the reflected laser light beam to various positions on the print-carrying medium, the distortion, if not desired, may be minimized by increasing the separation between the print-carrying medium and the reflector.

A cowl may be provided which encloses at least the reflector moving along the swath line with a linkage to drive from outside the cowl. The slot for the driving linkage to pass through and slide along may also serve as an air inlet or act as a secondary air inlet/leak path. Moving shuttering or brushes may be provided to limit the opening whilst allowing the linkage to slide along.

We have further described a preferred print removal device which comprises a collection unit for collecting the removed print. The collection unit may, in some devices, comprise one or more filters for filtering particles of the removed print debris. The one or more filters may, for example, be carbon filters and/or nano-particle filters.

We have further described a preferred print removal device, whereby the print removal device further comprises an extraction system for extracting the removed print from an area of the print-carrying medium at which the print has been removed. The extraction system may be connected to the collection unit, as will be further described below.

We have previously described in our pending GB patent application 1408695.3 a scheme for extraction with a flexible pipe/hose and a nozzle moving with the laser head on a carriage, which is incorporated herein by reference in its entirety.

We have further described a preferred print removal device, whereby the extraction system is configured to provide an air-flow in the print removal device, wherein the air-flow carries particles of the removed print, and wherein an air-flow direction of the air-flow is substantially perpendicular to a beam direction of the controllable laser light beam provided by the laser light source. Providing an air-flow in a direction substantially perpendicular to the laser light beam direction advantageously allows for protecting the laser light source and/or the reflector from accumulation of removed print debris (and/or dust). Cleaning mechanisms which would add complexity to the system, and would otherwise be necessary for cleaning in particular optical devices of the print removal device, may therefore be omitted in examples of the present print removal device. The preferred air-flow direction further allows for avoiding leakage along the length of the path perpendicular to the print-carrying medium movement direction to/from the medium path which may result in a higher air-flow at one end than the other. A further key benefit arises as the air-flow is applied transversally across the swath line and carrier. This allows the air-flow to be well-balanced across the entire “unprint” swath. Any effects of air leakage from this path to the paper track are likely to be similar across the length of the “unprint” swath, therefore allowing a lower peak air-flow than if the air-flow were along the line of the “unprinting” swath. Another key benefit of having the air-flow in the direction of movement of the print-carrying medium is that the air-flow is perpendicular to the laser light beam, meaning that it can be baffled to flow past and around the optical input port and the reflector without obstructing them.

The “unprinting” process with a laser ablates the print into the immediately surrounding air. It is therefore desirable to extract and collect the print once it has been removed.

We have further described a print removal device for removing print from a print-carrying medium, in particular the print removal device as outlined in any of the examples above, the print removal device comprising: a system to remove the print from the print-carrying medium along a swath line, in particular a laser light source for providing a controllable laser light beam; an extraction system for extracting particles of the removed print; and a collection chamber connected to the extraction system, wherein the collection chamber is configured to collect removed print debris extracted by the extraction system; wherein the extraction system includes an air inlet having an inlet aperture shape adapted to match the swath line, to entrain the particles of removed print from the swath line; and/or wherein a cross-sectional area of air flow through the extraction system enlarges at a collection chamber region such that a speed of the air flow reduces to promote settling of the particles in the collection region.

The collection chamber may be an enlarged collection chamber (“debris chamber”) which may accommodate large volumes of “unprinting” waste from ablation of print. In some devices, the collection chamber may comprise a serpentine flow path to permit settling of the removed print debris in the collection chamber. Additionally or alternatively, baffles may be provided for further enhancing settlement of the removed print debris in the collection chamber.

In some devices, a narrow, elongated opening adjacent to the laser swath line may be provided in order to extract removed print (debris) from a section or all of the “unprinting” swath. The narrow opening allows increased air-flow over the region of the print-carrying medium which is exposed to the laser light beam to provide extraction. The opening may be formed by a manifold, which may for example be injection moulded or otherwise formed at low cost to enclose the air-flow and also provide guiding for the removed print path.

The narrow, elongated opening for drawing air and ablation debris along the “unprint” swath by constraining the cross-sectional area advantageously increases an air-flow across the area of interest. An air-flow path may be provided from the narrow, elongated opening to the extraction system.

A cowl, for example the cowl as outlined above, in which the manifold may be arranged, may provide for shielding from the laser light beam.

The manifold may further locate media drive or nip components such as rollers which may be sprung against cooperating components on the other side of the media path to provide a pinch drive to the media. The manifold may also form one or more parts of the media guide. Furthermore, the manifold may locate sensors such as image sensors, edge detectors, thickness detectors, code readers or other devices.

It may be preferable to slow down particles of the removed print in the collection chamber to thereby collect the majority of particles in the collection chamber.

Therefore, as outlined above, in some devices a cross-sectional area of air flow through the extraction system enlarges at a collection chamber region such that a speed of the air flow reduces to promote settling of the particles in the collection region.

The speed of air-flow in the collection chamber is therefore reduced compared to the air-flow in the extraction system, which slows down the particles when they arrive in the collection chamber. The cross-sectional area of the collection chamber may therefore be larger than those of an inlet nozzle of the extraction system and of a linkage (conduit, duct or pipe) of the extraction system connecting the inlet nozzle with the collection chamber. The air-flow rate in the collection chamber is therefore rapidly reduced. Preferably, baffles may be provided in the collection chamber (and/or the extraction system) to extend the air-flow path, to thereby collect the majority of particles in the collection chamber. This is particularly advantageous when one or more filters are provided in addition to the collection chamber, as described below.

It will be appreciated that one or more collection chambers (in sequence) may be exploited. Even though using a plurality of collection chambers in sequence may increase the volume of the print removal device, this may still be advantageous as the air-flow in the collection chambers may be progressively slowed down to increase accumulation of the removed print in the collection chambers prior to any filter(s) which may be exploited to collect fine particles.

We have further described a preferred print removal device which comprises one or more filters, wherein the collection chamber is arranged between the extraction system and the one or more filters. Where collection chamber and one or more filters are used, it is particularly preferable to slow down the particles as outlined above once they arrive in the collection chamber to collect the majority of particles of the removed print in the collection chamber. A lifetime of the one or more filters may therefore be advantageously improved as they may filter a lesser amount of particles. At the same time, the collection chamber has a comparatively large volume so that the majority of the removed print may be collected in the collection chamber, rather than filtered by the one or more filters.

Collecting the majority of particles in the collection chamber may be further advantageously enhanced using other means, as will be described below.

We have further described a print removal device for removing print from a print-carrying medium, in particular the print removal device as outlined in any of the above described devices, the print removal device comprising: a system to remove the print from the print-carrying medium; an extraction system for extracting particles of the removed print; and a collection chamber connected to the extraction system, wherein the collection chamber is configured to collect removed print debris extracted by the extraction system, wherein the collection chamber comprises an electrical element for applying an electric field to particles of the removed print received from the extraction system in the collection chamber for electrostatic collection of the particles. The particles themselves may or may not be electrically charged. Even if the particles are not charged, they may be attracted to the electrical element due to their dipole moment.

It will be appreciated that one or more of the electrical elements may be exploited in the collection chamber. The electrical elements may be tracks on a printed circuit board, for example a flexible printed circuit board. Alternatively or additionally, the electrical element(s) may be provided as a wire or wires.

The electrical element may be, for example, one or more conductive or charged wires. These elements, as outlined above, may be used to apply a biasing electrostatic potential to attract debris particles. The cowl may protect the user of the print removal device from a (potentially) relatively high voltage applied to the electrical element(s). The electrical element(s) may be press fitted through interface slots in the enclosure or may be inserted into the collection chamber when it is moulded or otherwise manufactured. Alternatively, the electrical element(s) may be formed on a circuit board which may be conventional and/or flexible or of a flexi-rigid type forming the connections both inside and outside the collection chamber.

Throughout the description, the system to remove print from the print-carrying medium may, for example, be a laser light source as described herein. Alternatively, abrasion or a chemical technique may be used to remove print from the print-carrying medium. The skilled person will be familiar with alternative techniques for removing print, and it will be appreciated that a certain technique may be particularly suitable for removing a specific type of print.

The collection in the collection chamber may be further enhanced by charging the particles prior to their arrival in the collection chamber. Therefore, we have described a preferred print removal device which comprises a charging device for electrically charging particles of the print prior to receiving the removed print in the collection chamber, wherein the charging device is configured to charge the particles before and/or after the removal of the print by the system.

The charging device may comprise one or more conductive and/or electrostatic elements, for example a carbon brush which may be disposed in close proximity to, or touch, the print-carrying medium before the “unprinting” position so as to pre-charge the print-carrying medium and hence the print thereon. The print may be charged with an opposite charge compared to the electrical element(s) in the collection chamber to enhance attraction of the particles to the electrical element(s) in the collection chamber.

Additionally or alternatively, particles of the print may be charged in the air-flow path between the area at which the print has been removed and the collection chamber. For example, one or more charged plates may be provided in the air-flow next to the ablation area and/or at one or more locations in the air-flow path between the ablation area and the collection chamber to charge the particles prior to their arrival in the collection chamber.

Where the print-carrying medium is charged before ablation, then conductive elements (for example a carbon brush) may be disposed in close proximity, or touch, the print-carrying medium after ablation, whereby the conductive elements may be at earth potential so as to discharge areas of the medium which have passed the ablation area.

The collection chamber and/or the filters, which may be combined in a single unit rather than being separate, individual elements, may be replaced once a certain amount of removed print has been collected. It may also be replaced if the element is malfunctioning. It may therefore be desirable to predict and/or indicate when an element of the collection system (which may comprise the collection chamber and/or one or more filters) should be replaced.

We have further described a print removal device for removing print from a print-carrying medium, in particular the print removal device as outlined above, the print removal device comprising: a system to remove the print from the print-carrying medium; a collection system configured to collect the removed print; and a replacement determination system for predicting and/or indicating when an element of the collection system should be replaced. As outlined above, it may be desirable to predict when and/or indicate that the element should be replaced due to an amount of the removed print collected in the collection system and/or due to a malfunctioning element.

We have further described a preferred print removal device which comprises a laser light source for providing a controllable laser light beam configured to remove said print from said print-carrying medium, wherein the collection system comprises one or both of a collection chamber and one or more filters. Examples of the print removal device therefore allow for predicting and/or indicating when an amount of print collected in the collection chamber and/or in the one or more filters is above a threshold (and/or when the collection chamber and/or the one or more filters are malfunctioning).

Various devices and methods may be used alone or in combination in order to predict and/or indicate when an element of the collection system should be replaced. Therefore, we have further described a preferred print removal device, whereby the replacement determination system comprises one or more of: a flow sensor for sensing an air-flow generated by a fan of the print removal device, wherein the air-flow carries particles of the removed print; an electrical sensor for measuring a power consumption and/or speed of the fan (directly or indirectly), for example by measuring current consumption; a pressure sensor for measuring an air pressure in the print removal device; a sensor for measuring a weight or volume of the collected, removed print; and a device for determining and/or counting one or more of: a total usage time of the laser light source, a total area of the print removed from the print-carrying medium, and a total number of unprinted print-carrying media.

The air-flow may reduce as the collection chamber and/or the one or more filters become clogged. This may be detected by the flow sensor as the air-flow may be below a first threshold. References to clogged (or nearly clogged) throughout the description refer equally to the collection system being full (or nearly full) of collected, removed print.

The fan of the print removal device may use less power because less mechanical work is being performed if the collection system is clogged. Hence, it may be detected that the power consumption of the fan is below a second threshold. Alternatively, the fan may be controlled such that a constant or nearly constant air-flow in the print removal device is guaranteed (or aimed for). In this case, if the collection system becomes clogged, the rate of the fan needs to go up, thereby consuming more power. Therefore, a clogged collection system (or nearly clogged collection system) may be detected if the power consumption of the fan is above a pre-defined threshold. Additionally or alternatively, the speed of the fan may be measured. This is preferably detected by sending the electrical current to the motor or by measuring the fan motor's backwards electromotive force (back-EMF) developed, which is approximately proportional to speed. Whether the collection system is full (or nearly full) may therefore be predicted and/or indicated if the speed is above a threshold.

If there is no speed control on the fan the speed of the fan may go up if the collection system is (nearly) full, for example if a filter is clogged, as less work is done by the fan in moving the restricted air-flow. In this case, a prediction of a full (or nearly full) collection system may be made if the fan speed is above (or rises by more than) a threshold. Additionally or alternatively a flow sensor may be employed to detect reduced air-flow in the print removal device and hence make a prediction of a full (or nearly full) collection system.

It is to be noted that the one or more fans described throughout the specification may blow air or suck air to provide an air-flow in the print removal device.

It may alternatively or additionally be predicted and/or indicated that the collection system is full (or nearly full) if the pressure in the print removal device is above a threshold. This may be due to, for example, a filter which may be clogged while the fan is still generating an air flow in the print removal device, thereby building up pressure in the device. The pressure may be measured before, and/or after, and/or differentially across the fan(s) or filter(s).

The amount of the removed print debris collected in the collection system may alternatively or additionally be measured using a sensor which is integrated into the collection system. Whether the collection system is full (or nearly full) may therefore be predicted and/or indicated if the weight or volume of collected print is above a threshold.

The amount of removed print debris collected in the collection system may alternatively or additionally be determined by determining/measuring the total usage time of the laser light source, which may correlate to the amount of collected print debris. It will be appreciated that in some devices the laser light source may only be used once print has been detected on a medium by a sensor, e.g. the sensor described above. Therefore, if the total usage time of the laser light source is above a threshold, it may be determined that the collection system is clogged (or nearly clogged), and an element of the collection system should therefore be replaced. The total usage time may be given in hours, hours and seconds or other time periods.

Similarly, the total area of print removed from print-carrying media may additionally or alternatively be determined, as this may be a measure of the amount of removed print debris collected in the collection system. The total print area may be determined by integrating the printed media over time. If the total area is above a threshold, it may be determined that the collection system is clogged (or nearly clogged), and an element of the collection system should therefore be replaced.

Similarly, the total number of print-carrying media (e.g. papers) may additionally or alternatively be determined, as the total amount of print-carrying media from which print has been removed may be a measure of the amount of removed print debris collected in the collection system. Therefore, if the total number is above a threshold, it may be determined that the collection system is clogged (or nearly clogged), and an element of the collection system should therefore be replaced. It will be appreciated that this may be a less precise method of determining whether the collection system is clogged (or nearly clogged), as the information of the total number of pages does not necessarily correlated to the exact amount of print removed from print-carrying media. This is because some media may carry less print than others. In some devices, this may be accounted for by correlating a count of a single print-carrying medium to an average amount of print being removed from a print-carrying medium.

As outlined above, some areas of the print-carrying medium may overlap, therefore exposing some pixels or locations of the print-carrying medium multiple times. This may be taken into account when determining the total amount of print removed from the print-carrying medium by processing information about which areas have been exposed and for how long/often.

We have further described a method for predicting and/or indicating when an element of a collection system for collecting print removed from one or more print-carrying media with a print removal device should be replaced, the method comprising removing the print from the one or more print-carrying media, in particular using a laser light source of the print removal device; the method further comprising one or more of:
a) sensing an air-flow in the print removal device, wherein the air-flow carries particles of the removed print;
b) measuring a power consumption of a fan of the print removal device, wherein the fan is configured to control the air-flow;
c) measuring a speed of the fan;
d) measuring a pressure in the print removal device;
e) measuring a weight or volume of the collected, removed print;
f) determining a total usage time of the laser light source;
g) determining a total area of the print removed from the one or more print-carrying media; and
h) counting a total number of print-carrying media from which the print has been removed,
the method further comprising predicting and/or indicating when the element should be replaced if one or more of:
1) the air-flow is below a first threshold;
2) the power consumption is below or above a second threshold;
3) the speed is above a third threshold;
4) the pressure is above a fourth threshold;
5) the weight or volume is above a fifth threshold;
6) the total usage time is above a sixth threshold;
7) the total area is above a seventh threshold; and
8) the total number is above an eighth threshold.

We have further described a preferred method which comprises alerting a user of the print removal device in response to the prediction and/or indication that the element of the collection system should be replaced. The print removal device may therefore comprise an indicator to signal the prediction and/or indication to the user. Preferably, the system may indicate in cases where multiple elements are used in the collection system, which (one or more) of these elements should be replaced.

We have further described a print removal device for removing print from a print-carrying medium, in particular the print removal device as outlined above, the print removal device comprising: a feed system for receiving the print-carrying medium and guiding the print-carrying medium through the print removal device; and a system to remove said print from said print-carrying medium, in particular a laser light source for providing a controllable laser light beam to remove the print from the print-carrying medium; wherein the feed system comprises a media guide comprising an inflection configured to bias the print-carrying medium towards a face of the print-carrying medium which faces away from the laser light source when the print-carrying medium is guided through the print removal device.

We have further described a preferred print removal device, whereby the laser light beam may transition from one side of the print-carrying medium to the other side, which may require unobstructed access from the reflector to the print-carrying medium (substantially) across its full width. It may be undesirable to create such gaps in the media guide as they present edges that may cause flexible media, such as paper, to catch.

Therefore, providing a media guide comprising an inflection as outlined above allows for minimising or eliminating problems associated with a print-carrying medium being caught by such edges. The inflection which provides for the above-specified bias to the print-carrying medium advantageously allows minimising or eliminating non-uniformities in the laser power delivered to the print-carrying medium which may otherwise occur if features crossing the gap are caught by any edges.

It will be appreciated that in any of the devices described herein, the print removal device may be operated in a bi-directional mode. For example, the print-carrying medium may be guided from one side of the print removal device via the laser light exposure area to the other side. This may allow for removing print on a first surface of the print-carrying medium. The print-carrying medium may be turned around (automatically or manually) at the other side and guided through the print removal device to remove any print on the other surface of the print-carrying medium.

Therefore, we have further described a preferred print removal device, whereby the media guide comprises a first said inflection at a first location of the media guide and a second said inflection at a second location of the media guide, wherein the first and second locations are located on opposite sides in a direction of the guiding of the print-carrying medium through the print removal device with respect to an area of the print removal device at which the print-carrying medium is exposed to the laser light beam.

The plates or moulding forming the media guide on one or both sides of the slot at which the print-carrying medium may be exposed to laser light may be profiled to encourage the media to carry on in the track of the guide after the slot. This may be particularly important for used media which may, in extreme cases, have been rolled up.

The inflection(s) further advantageously allow(s) for a constant separation of the print-carrying medium to the reflector. A constant optical path is particularly important where focusing of the laser light beam and/or a predictable distortion of the laser light beam are required by having a specific focal length to the print-carrying medium.

We have further described a preferred print removal device, whereby the media guide comprises a plurality of wires for guiding the print-carrying medium through the print removal device, and wherein one or more gaps between the plurality of wires are configured to allow the print-carrying medium to be exposed to the laser light beam. Preferably, the wires are deployed at an angle greater than zero with respect to a direction of motion of said print-carrying medium in said print removal device such that the laser light beam can access all parts of the print-carrying medium in an area of the print removal device at which the print-carrying medium is exposed to the laser light beam (i.e. the slot described above). The wires may be relatively thin, and may be made of, for example, stainless steel.

However, there remains a need for further improvement.

Cartridges

In a first aspect of the invention, there is therefore provided a print removal system for removing print from a print-carrying medium, the print removal system comprising one or more slots for receiving one or more cartridges configured to collect removed print debris.

References to “slot” throughout the description are not necessarily limited to a particular shape and/or size of the slot. For example, a “slot” is not necessarily to be interpreted as to a narrow, elongated gap. A “slot” is rather to be interpreted generally as a bay or receptacle, i.e. a space which allows insertion of one or more elements, such as, e.g. a cartridge filter unit and/or a debris chamber.

The inventors have realised that cartridges which may collect print debris removed from the print-carrying medium might become clogged and/or might be malfunctioning. Providing one or more slots advantageously allows for replacing a cartridge used in the print removal system if the cartridge becomes clogged or is malfunctioning. The cartridges may comprise one or more collection chambers and/or one or more filters as will be further described below, allowing collection/filtering of the removed print debris. We note that where references throughout this description are made to print being collected in a cartridge, this equivalently refers to print being filtered in a cartridge, except where specifically indicated.

Preferably, the print removal system comprises an extraction system comprising an exhaust channel for extracting the removed print debris. The one or more slots preferably intersect the exhaust channel of the extraction system. Therefore, by inserting the one or more cartridges into the one or more slots, the removed print debris may be collected in the one or more cartridges. It will be understood that the one or more slots may be arranged in the print removal system such that the one or more cartridges may be provided at an intermediate location in the exhaust channel, and/or at one or both ends of the exhaust channel.

The one or more slots may be configured such that the one or more cartridges, when inserted into the one or more slots, form at least a part of the exhaust channel. Embodiments further allow for convenient cartridge exchange for service and/or replacement. It will be appreciated that in this embodiment a safety mechanism may be employed allowing a user to operate the print removal system only when the exhaust channel is completed by inserting one or more cartridges, as applicable. Such safety mechanisms will be further described below.

Additionally or alternatively, the print removal system may comprise an access panel, door or other means to open the exhaust channel to allow filter material, which may in some examples not be contained in a cartridge, to be positioned or replaced. However, it will be appreciated that filters may be flexible and may therefore be prone to user-error which may cause the performance of the system to degrade or be inadequate.

Various mechanisms may be employed in the print removal system in order to ensure that a cartridge is inserted in a correct slot and/or in a correct orientation. It may further be preferable to ensure that in case a plurality of cartridges is used that the cartridges are inserted into the slots of the print removal system in the correct sequence.

Therefore, in a preferred embodiment, the print removal system further comprises a detector for detecting when a cartridge has been inserted into a said slot. This detector may be used to ensure that the exhaust channel of the extraction system is completed by the one or more cartridges before the print removal system may be operated. An indication or warning may be provided to the user to indicate that the print removal system may not be operated as long as the exhaust channel has not been completed.

In a preferred embodiment of the print removal system, the detector comprises one or more switches which are configured to switch when a cartridge has been inserted into a slot. Such a switch may be an opto-coupler or a micro-switch. It will be appreciated that some slots may be provided with opto-couplers while others are provided with micro-switches. Furthermore, one slot may comprise more than one switch, in which case the slot may comprise one or more micro-switches and one or more opto-couplers.

As outlined above, it may be preferable to ensure that a correct cartridge is inserted into a certain slot. Therefore, the detector of the print removal system may preferably be configured to detect and identify specific cartridge types or models.

Therefore, in a preferred embodiment of the print removal system, the detector comprises one or more tag readers configured to detect a tag of a cartridge. The tag may thereby be preferably detected only if its distance to the tag reader is below a threshold distance.

In a further preferred embodiment, the print removal system further comprises a processor and a memory, wherein a said tag reader is configured to receive information from a said tag about a type or model of a said cartridge, and/or information about a usage of a said cartridge, and/or information about a said print removal system in which a said cartridge has previously been used, and wherein said received information is processed by the processor and stored in the memory. Preferably, the tag reader, the processor and the memory are integral to a tag read unit.

A message may be signalled to the user specifying the above information. The information may further be used to signal a warning to the user if the cartridge is not compatible with the print removal system and/or if the cartridge should not be used as it is clogged or malfunctioning, which may have been determined previously.

In a preferred embodiment of the print removal system, the detector is configured to detect a barcode on a said cartridge. This may allow for obtaining information about a type or model of a cartridge, and/or information about a usage of a cartridge, and/or information about a print removal system in which a cartridge has previously been used. This information may be processed by a processor and, optionally, stored in a memory. It will be appreciated that the processor and memory may be integral to those specified above. Furthermore, similarly to the response to the information obtained via a tag, a message may be signalled to the user specifying the information obtained via the barcode. The information may further be used to signal a warning to the user if the cartridge is not compatible with the print removal system and/or if the cartridge should not be used as it is clogged or malfunctioning, which may have been determined previously.

In a further preferred embodiment of the print removal system, a said slot comprises a slot mating feature for interfacing with a cartridge mating feature on a said cartridge for ensuring that a correct said cartridge is inserted into a said slot and/or that a said cartridge is inserted into a said slot in a correct orientation.

The slot mating feature and cartridge mating feature further allow ensuring that a correct sequence of filters in the cartridges is inserted into the slots.

The one or more slots may alternatively be formed with non-interchangeable shapes. For example, they may be keyed, or one slot may be short and fat and another slot may be tall and thin. Alternatively or additionally, a slot may have a complex shape such as a shallow “U” or “C” shape such that the orientation of a cartridge to be inserted into a slot may be immediately apparent to the user without the need to think about mating features or look, for example, for orientation arrows.

Preferably, the slot mating feature is formed of a rib configured to penetrate the cartridge mating feature. The rib may project from a manifold which penetrates the cartridge mating feature on the cartridge in a particular location, preferably from the top to bottom of one or more cartridge sides, which may also be used for guiding as the cartridge is inserted.

Alternatively, the features may be reversed or may be formed of rod-like or blade-/rib-like projections from the cartridge slot base that penetrate into receiving features in the cartridge and may be different between slot positions and cartridge types.

Therefore, in a preferred embodiment of the print removal system, the slot mating feature is a rib projection configured to receive the cartridge mating feature in the form of a rib on the cartridge.

The cartridge mating features may be different between cartridge filter locations so that the type of filter inserted is limited to one of two or more filter options in order to ensure that the filters are inserted in the flow path in the correct positions so that they are in the correct sequence in the exhaust air flow channel. For example, the removed print debris may first be filtered by a hepa filter, and afterwards by a carbon filter.

Therefore, in a preferred embodiment of the print removal system, a first said slot comprises a slot mating feature which is different from a slot mating feature of a second said slot.

In a further preferred embodiment, at least two of the slots comprise different shapes and/or sizes. Each one of the slots may preferably comprise a shape and/or size which are different from a shape and/or size of any of the other slots.

In a further preferred embodiment of the print removal system, the one or more slots are arranged on a side of a fan of the print removal system, wherein the fan is configured to generate an air-flow in the print removal system for extracting the removed print debris from an area of the print removal system at which the print has been removed from the print-carrying medium, and wherein the side faces towards said area.

Arranging one or more filters in front of the fan in an air-flow direction of an air-flow carrying the removed print debris allows for the fan to run in clean air with the filters capturing any remaining debris beforehand.

It will be appreciated that various of the above-specified embodiments are equally suitable in a print removal system in which the collection unit merely comprises a debris collection chamber, rather than one or more filters. However, it will be understood that preferably, a debris collection chamber is used in front of the one or more filters in the direction of air-flow in the exhaust channel to collect most of the removed print debris in the debris collection chamber (which may have a larger volume). This may advantageously increase the life-time of the filter(s).

Alternatively one or more filters may be located behind the fan(s) in the direction of air-flow in the print removal system. In this case contaminated air may pass through the fan(s) before being filtered out. An advantage of this arrangement is that the filter cartridge(s) may be clipped or stacked on the outside of the ducts over the fan port(s) rather than inserted into the air flow exhaust channel in front of the fan(s).

In some embodiments, the fan(s) may blow the removed print debris rather than suck it.

The section of the manifold, which may comprise filter cartridge(s) and debris chamber(s), or duct with the cartridge receiving portions may be separated from the immediate print removal station/device. The fan(s) and the manifold may further be distributed and connected to each other by one or more pipes, one or more flexible or rigid ducts and/or one or more tubes.

Therefore, in a preferred embodiment of the print removal system, the print removal system comprises a print removal device for removing the print from the print-carrying medium, wherein the one or more slots are separated from the print removal device, and wherein the one or more slots are connected to the print removal device via an air-flow channel.

According to a related aspect of the invention, there is provided a cartridge configured to be inserted into one or more of the slots of the print removal system of any of the embodiments described herein.

Preferably, the cartridge comprises one or both of a collection chamber and one or more filters for collecting the removed print debris. The filters may be housed in one or more cartridges. It will be understood that a single filter material may be arranged in a cartridge, or two or more filter materials may be arranged in a cartridge.

In case two or more filters are exploited, the filters may be different. For example, a filter may be coarse or fine, it may be suitable for collecting nano-particles, or a carbon filter may be used, to neutralise certain gases and/or odours that may arise.

As outlined above with regard to the print removal system, an electronic tag of a cartridge may be read by the print removal system.

Therefore, in a preferred embodiment, the cartridge comprises an electronic tag configured to be read by a detector of the print removal system and to provide information to the print removal system about a type or model of a the cartridge, and/or about a usage of the cartridge, and/or about a the print removal system in which the cartridge has previously been used, in particular wherein the electronic tag is configured to be written to by said print removal system. This information may then be used to determine, for example, whether a specific filter which may be arranged in the cartridge is inserted into the correct slot of the print removal system, and/or whether the filter is clogged/full or malfunctioning (which may have been determined previously). It will be appreciated that the cartridge may have a processor and/or memory which may be used to store the above information about the cartridge and/or filter. Alternatively, the processor may be external to the cartridge which comprises a memory which may be accessed to obtain information about the cartridge and/or filter.

Alternatively or additionally, a barcode may be provided on the cartridge such that it may be read as it is inserted by wiping past a sensor, or it may be read once in position.

Therefore, in a preferred embodiment, the cartridge further comprises a barcode configured to be read by a detector of the print removal system and to provide information to the print removal system about a type or model of a the cartridge, and/or about a usage of the cartridge, and/or about a the print removal system in which the cartridge has previously been used. As outlined above, this information may be stored in a memory integral to the cartridge unit.

In a further preferred embodiment, the cartridge further comprises a cartridge mating feature configured to interface with a slot mating feature of a said slot of the print removal system for ensuring that the cartridge is inserted into a correct said slot and/or in a correct orientation.

This may be particularly important when a plurality of filters may be used, such that the filters are positioned in the air-flow of the exhaust channel in the correct sequence and/or orientation.

In embodiments where there is more than one filter and the filter materials are consumed at a similar rate, or may be economically packaged and changed together, a hybrid or laminated filter may be used, allowing some or all filters required to be housed together. It may also be important in this case to place the filters in the correct orientation into the exhaust channel so as to ensure that the filters are placed in the slot(s) in the correct sequence.

In a preferred embodiment, the cartridge further comprises a connector configured to connect the cartridge to a second said cartridge, and wherein the connector has a shape and/or size which allow only specific cartridges to be connected to each other.

This may equivalently ensure that where a plurality of filters is used, they are positioned in the exhaust air-flow channel in the correct sequence.

It may be important that the filters are correctly fitted prior to the print removal system being operated. Therefore, the filter material may be clipped or positioned in the airflow by handling the filter material directly, then actuating clips, and/or springs, and/or grills to retain the filter material. Since the filter material may be flexible, or should not be deformed or compressed, it will be appreciated that the filter material may be damaged by handling it directly and it may be fitted incorrectly since a flexible material may be difficult to position exactly in such situations. It may be difficult and potentially unreliable to detect the type of filter material directly to confirm the correct sequence where more than one filter material is installed, or that any filter material has been installed at all.

In a preferred embodiment, the cartridge further comprises a grid configured to retain a filter material and to allow air to penetrate the filter material. The grid preferably comprises members for re-directing an air-flow within the cartridge (for example via a serpentine flow path). This may advantageously allow for controlling an amount of removed print debris settling in the cartridge.

In a further preferred embodiment, the cartridge further comprises a seal configured to engage with one or both of a said seal of a second cartridge and a slot of the print removal system, so as to seal an exhaust channel of the print removal system. This advantageously allows ensuring that no removed print debris may exit the print removal system which may otherwise cause harm to the user of the system.

It will be appreciated that a cartridge may be provided with a filter material whereby the filter material is fixed in the cartridge. The whole cartridge may then be replaced if the filter material is clogged and/or malfunctioning. Alternatively, the cartridge may be opened to only replace the filter material itself such that the cartridge may be re-used.

In a related aspect of the invention, there is therefore provided a filter unit comprising the cartridge of any of the embodiments described herein, and a filter configured to filter print debris removed from a print-carrying medium with a print removal system.

As outlined above, the filter may be a coarse filter or a fine filter. It may be a nano-particle filter or a carbon filter. Further filter materials will be known to those skilled in the art, and certain filter materials may preferably be exploited depending on the type of print removed, and/or the type of medium carrying the print which is to be removed.

A single filter material may be provided within the cartridge, or a plurality of filter material (potentially in a particular sequence) may be arranged in the cartridge.

In some embodiments, the cartridge is formed of two parts. Preferably, the first part is the same for all cartridge options and the second part is selectable having a portion to exclude the possibility of inserting a given type into an incorrect slot. As outlined above, the shape and/or size of the overall cartridge or the configuration of at least one portion of at least one part may be used to ensure that the orientation of some or all of the cartridges is controlled. The same variable portions or another portion of at least one part is also formed in such a way that it may be detected when correctly positioned by a switch, which, as outlined above, may preferably be an opto-coupler.

In a related aspect of the invention, there is provided an unprinter filter cartridge, the filter cartridge comprising one or more of: an identifier readable by a mating unprinter to identify a type of the filter cartridge; a communication device to cooperate with a reader of the unprinter to communicate an identity or characteristic of the filter cartridge, in particular a measure of a remaining operational life of the filter cartridge; a mechanical interface to selectively interface with a second filter cartridge to ensure multiple cartridges fitted within said unprinter are of defined types and/or have a defined sequence with respect to an air-flow within the unprinter; a seal to cooperate with a second filter cartridge to ensure multiple cartridges fitted within said unprinter define a mutual seal to define an air-flow through the cartridges; a mechanical slot to, when fitted, receive a projection of said unprinter to define an orientation of the cartridge within the unprinter.

In a further related aspect of the invention, there is provided an unprinter fitted with one or more of the above-described filter cartridges.

We note that any of the embodiments of the present invention may be combined with any one or more of the features of the print removal system as described in our co-pending GB patent application filed by the same applicant on the same day as this application, as outlined above.

### BRIEF DESCRIPTION OF THE DRAWINGS

These and other aspects of the invention will now be further described by way of example only, with reference to the accompanying Figures, wherein like numerals refer to like parts throughout, and in which:

FIG. 1 shows examples of wavelength and pulse length operating regions illustrating a preferred region of operation for unprinting;

FIG. 2 shows a schematic, cross-sectional side-view of a module of a first embodiment of an unprinter according to the present invention;

FIG. 3 shows a schematic, cross-sectional side-view of a module of a second embodiment of an unprinter according to the present invention;

FIG. 4 shows a schematic, perspective view of an unprinting module according to embodiments of the present invention;

FIGS. 5a and 5b show schematic, cross-sectional front and perspective views of an unprinter module according to embodiments of the present invention;

FIGS. 6 and 7 show schematic, cross-sectional side-views of an air-flow path in an unprinter module according to embodiments of the present invention;

FIG. 8 shows a schematic of a spot size illustration of a laser light beam according to embodiments of the present invention;

FIG. 9 shows distortion of a laser light beam according to embodiments of the present invention;

FIG. 10 shows a schematic top-view of cartridge slots in an unprinter module according to embodiments of the present invention;

FIGS. 11a and 11b show filter cartridge and filter unit, respectively, according to embodiments of the present invention;

FIG. 12 shows a schematic, bottom view of two filter cartridges according to embodiments of the present invention;

FIGS. 13a to 13d show schematic, exploded and other illustrative views of filter units according to embodiments of the present invention;

FIG. 14 shows a perspective view of a schematic of a filter cartridge with a barcode according to embodiments of the present invention;

FIG. 15 shows a filter cartridge and print removal system with electronic tag and tag reader, respectively, according to embodiments of the present invention;

FIG. 16 shows a filter cartridge with a clip according to embodiments of the present invention;

FIG. 17 shows a filter cartridge with a seal according to embodiments of the present invention;

FIG. 18 shows a filter unit separated from the print removal system according to embodiments of the present invention; and

FIGS. 19a and 19b show a print removal system according to embodiments of the present invention.

### DETAILED DESCRIPTION OF PREFERRED EMBODIMENTS

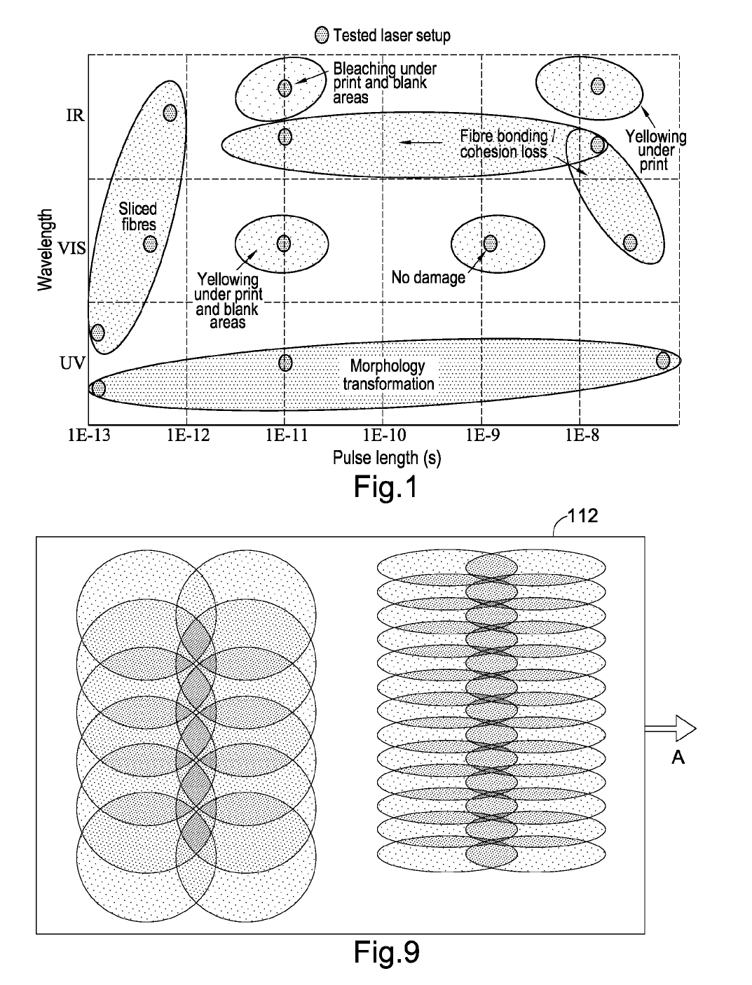

As outlined above, FIG. 1, which is taken from Proceedings of the Royal Society A: Mathematical, Physical and Engineering Science, 468(2144), 2272-2293, illustrates the relationship between wavelength, pulse length and paper damage, showing that the optimum wavelength is in the visible, around the green, and that the optimum pulse length is in the range 1-40 ns.

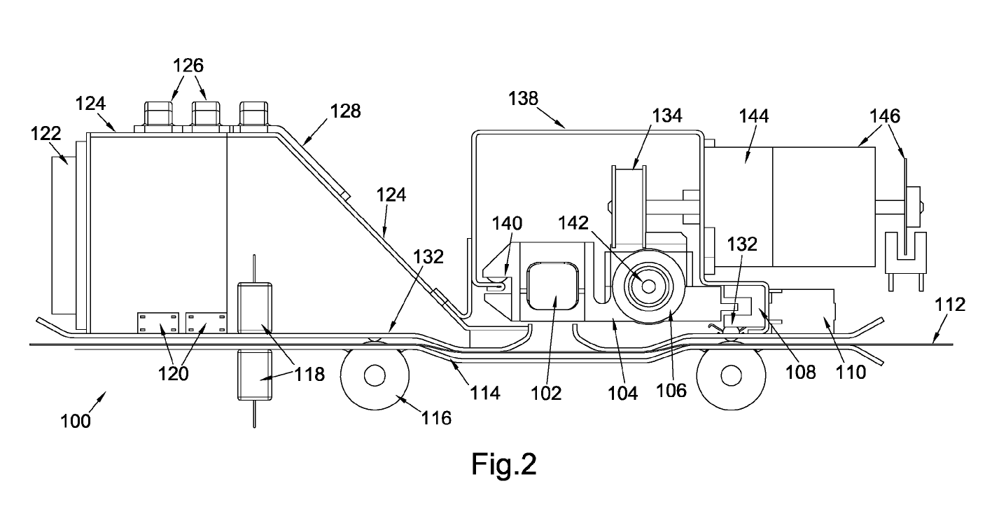

FIG. 2 shows a schematic, cross-sectional side-view of a first embodiment of an unprinter module 100 of an unprinter.

The unprinter module 100 has a mirror 102 which is configured to reflect a laser light beam (not shown in FIG. 2) onto a paper 112 which is fed through the unprinter.

In this example, the location of the mirror 102 is varied by driving it across the paper 112 using a carrier 104. The carrier 104 is mounted on an elongated carriage bearing 106, which itself is mounted on a carriage shaft 142. The elongated carriage bearing 106 minimises rotation and provides for a stable vibration free running on the carrier 104.

In this example, the carrier 104 is configured to position the mirror 102 at 45 degrees to the paper 112 to reflect the laser light beam injected through a side port (see below) perpendicular to the paper 112 onto the paper 112.

In order to vary the location of the mirror 102, the location of carrier 104 may be changed by driving a carriage drive belt 134 on pulleys. The carriage drive belt 134 is connected to a gearbox 144, which, in this example, is controlled by a DC motor and encoder unit 146. In this example, the gearbox 144 is integrated to the DC motor and encoder unit 146. The encoder comprises a position and speed feedback encoder formed, in this example, of slotted disks.

Controlling the DC motor and encoder unit 146 therefore allows for controlling the mirror 102 location, in this example, in a direction perpendicular to the direction of movement of the paper 112 in the unprinter module 100. Hence, the laser light beam may be directed towards different areas on the paper 112.

In this example, a rail runner 140 is provided to guide and control rotation of the carrier 104 mounted on the carriage shaft 142, thereby setting the mirror 102 position. The rail runner 140 further prevents excess rotation during transport, for example when the unprinting module 100 is upside down in some transport means.

In this embodiment, mirror 102, carrier 104, elongated carriage bearing 106 on carriage shaft 142, carriage drive belt 134 and rail runner 140 are arranged inside a large cowl 138. An advantage of arranging these features of the unprinter module 100 inside the cowl 138 is that dust surrounding the unprinter may not settle on any of the optical devices. Therefore, cleaning processes due to dust from the environment surrounding the unprinter are made redundant (although it will be understood that the optical devices may be cleaned on a regular basis due to removed print debris settling on these devices).

Since the laser light beam does not exit the cowl 138, the unprinter is safer to use.

As shown in FIG. 2, the unprinter module 100 is provided with a contact image sensor 110 and an opto-coupler 108 which interacts with the carrier 104 features. These optical elements are configured to sense a location of print on the paper 112 which is fed to the unprinter. As the opto-coupler 108 interacts with the carrier 104 features, the location of the mirror (and/or its tilt) may be varied to remove print on the paper 112 in response to the optical sensing with opto-coupler 108.

Biasing features 114 are provided on both side of the print removal area which cause inflection in the paper path directing paper 112 away from the scanning gap. As outlined above, this prevents paper 112 from catching at edges when fed through the unprinter module 100.

Biasing nip rollers 132 are provided on each side of the area at which print is removed from the paper 112. Media drive rollers 116 are arranged in the feed-through of the unprinter module 100 to control movement of the paper 112 in the unprinter.

The unprinter module 100 further comprises sensors 118 for reading marks on the paper 112. When unprinting the paper 112, it may be marked with a label, message and/or code to indicate that the paper 112 has been unprinted.

Filter detection opto-couplers 120 may be provided to ensure that the device is only operated while filters are inserted into the unprinter module 100.

It is to be noted that the entire upper assembly on its media guide plate may be mounted to hinge up or otherwise provide access to the paper path to allow clearance of jams. This may cooperate with a switch or opto-coupler to detect that the assembly is in position prior to operation.

The unprinter module 100 further comprises a manifold 124 comprising a debris chamber 128 and filters 126.

The debris chamber 128 may be a removable cartridge. Preferred embodiments of the debris chamber 128 are outlined above, and include, for example, a serpentine air-flow path to permit settling of removed print debris in the debris chamber 128.

Filters 126, in this example in cartridges, are provided behind the debris chamber 128. The filters 126 may be, for example, carbon filters and/or nano-particles filters.

As outlined above, it is preferable to place the filters 126 on the side of the debris chamber 128 facing away from the area at which print is removed from the paper 112.

This allows that the majority of the removed print debris is collected in the debris chamber 128, which increases the life-time of the filters 126.

In this embodiment, a fan 122 is placed behind the manifold 124, sucking air out of the inner part of the unprinter module 100. As outlined above, in alternative embodiments, the fan 122 is arranged on the opposite side to blow air into the inner part of the unprinter module 100. It will be understood that a plurality of fans 122 may be provided on one or both sides of the unprinter module 100.

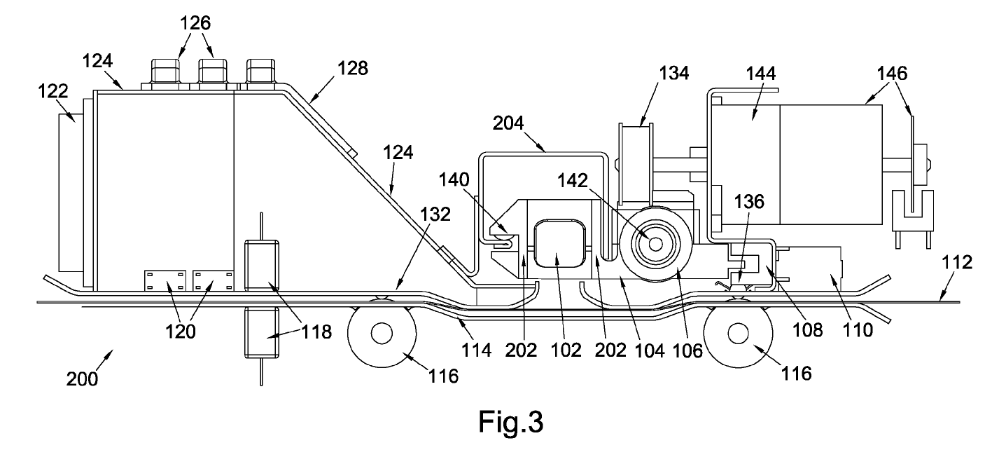

FIG. 3 shows a schematic, cross-sectional side-view of an unprinter module 200 according to a second embodiment of the unprinter.

In this example, the large cowl 138 is replaced with a small cowl 204. Merely the mirror 102, the rail runner 140 and a part of the carrier 104 are arranged inside the cowl 204.

An air baffle 202 is provided inside the cowl 204 to protect other (optical) sensors and the mirror 102 from debris accumulation (for small and large cowl versions).

As the volume of the cowl 204 is relatively small compared to the cowl 138 in the embodiment shown in FIG. 2, it is particularly important to extract the removed print debris away from components of the optical system (laser light source and mirror 102). Preferably, a long air gap is provided in the cowl 204 allowing sufficient air to be sucked into the cowl 204 to remove the print debris removed from the paper 112.

A linkage is provided between the carriage shaft 142 and carrier 104 carrying the mirror 102 in order to control the location of the mirror 102 inside the cowl 204.

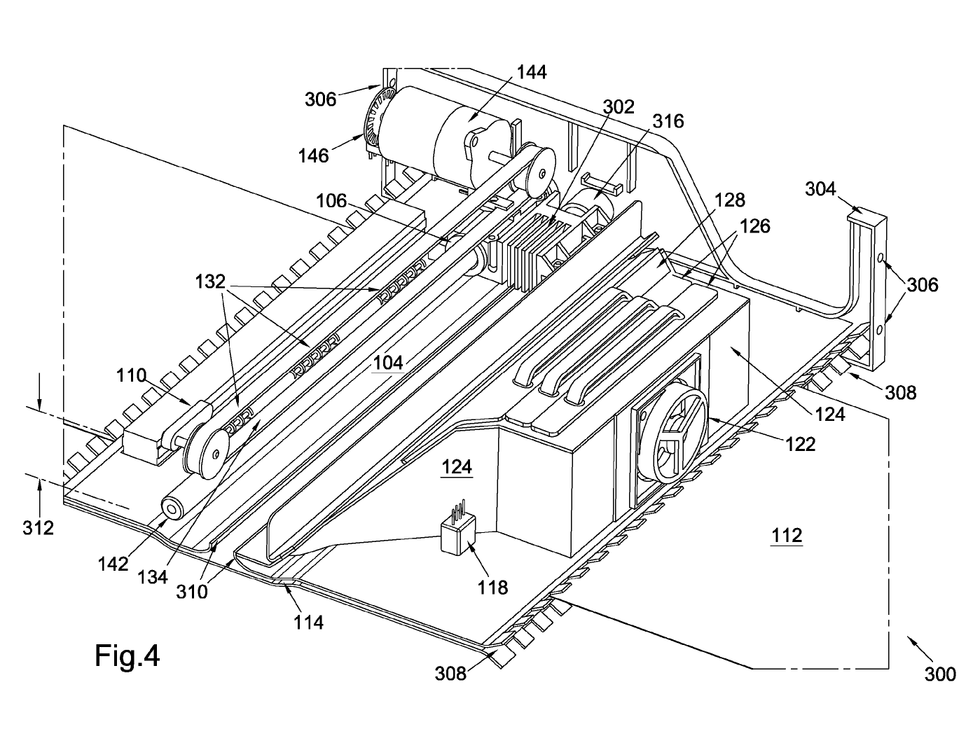

FIG. 4 shows a schematic, cross-sectional side-view of an unprinter module 300 of an unprinter. Some of the elements of the unprinter have been removed for clarity.

As can be seen, a laser entry port 316 with a baffle is provided in the unprinter module 300 in order to protect the laser light source from debris and dust accumulation.

Carriage cooling vanes 302 are arranged in the unprinter module 300 on the carrier 104 to prevent the carrier 104 and its drive mechanism from heating up.

In this example, a plurality of location features 306 for module alignment is provided on a side plate 304 (only one side plate 304 is shown for simplification).

As outlined above, it may be preferable to accelerate or decelerate the carrier 104 at edge regions of the unprinter module 300. Therefore, acceleration and deceleration regions 312 are provided on each side of the module 300. It may be preferable to provide for a longer travel of the carrier 104 than may be required just for the paper 112 width. The acceleration and deceleration regions 312 may thereby be provided at regions beyond areas at which the paper 112 is fed through the module 300.

The unprinter module 300 further comprises paper control features 308 on each side of the module 300. It will be appreciated that paper control features 308 may be necessary on one side only in case paper 112 is fed to the module 300 from one side only.

Further paper control features 310 are provided in a centre region of the unprinter module 300. It will be appreciated that a gap must be provided in the print removal region where the print is removed from the paper 112 by the laser light beam. Paper control features 310 are configured to avoid catching of the paper 112 at the edges forming the ends of the gap through which the laser light can penetrate. Therefore, as can be seen in FIG. 4, the paper control features 310 are bent upwards. Furthermore, small indents may be provided in the edges of the paper control features 310. An edge of the indents may also be slightly bent upwards so as to avoid catching of the paper 112 when being guided through unprinter module 300. Therefore, any edges defining the gap through which the laser light beam may penetrate to expose the paper 112 may be bent upwards to avoid snagging/catching of the paper 112 when being fed through the print removal area.

Additionally, wires (not shown) with gaps between them may be arranged across the gap through which the laser light can penetrate to remove print from the paper 112. These wires are used to guide the paper 112 and prevent the paper 112 from catching at edges of the paper guide defining the air gap. The wires span across the gap in a direction generally parallel to the direction of movement of the paper 112 in the unprinter module 300. Preferably, the wires are tilted, i.e. they span across the gap in a direction which is not exactly parallel to the direction of movement of the paper 112 in the unprinter module 300. This allows for the laser light beam to “see” all areas of the paper 112 when it is guided across and underneath the gap, in particular when the laser light beam is only projected onto the paper 112 at a 90 degree angle. Hence, if an area on the paper 112 is not accessible by the laser light beam during a first scan, it may be accessible during a later run once the paper 112 has been fed through the unprinter module 300 further.

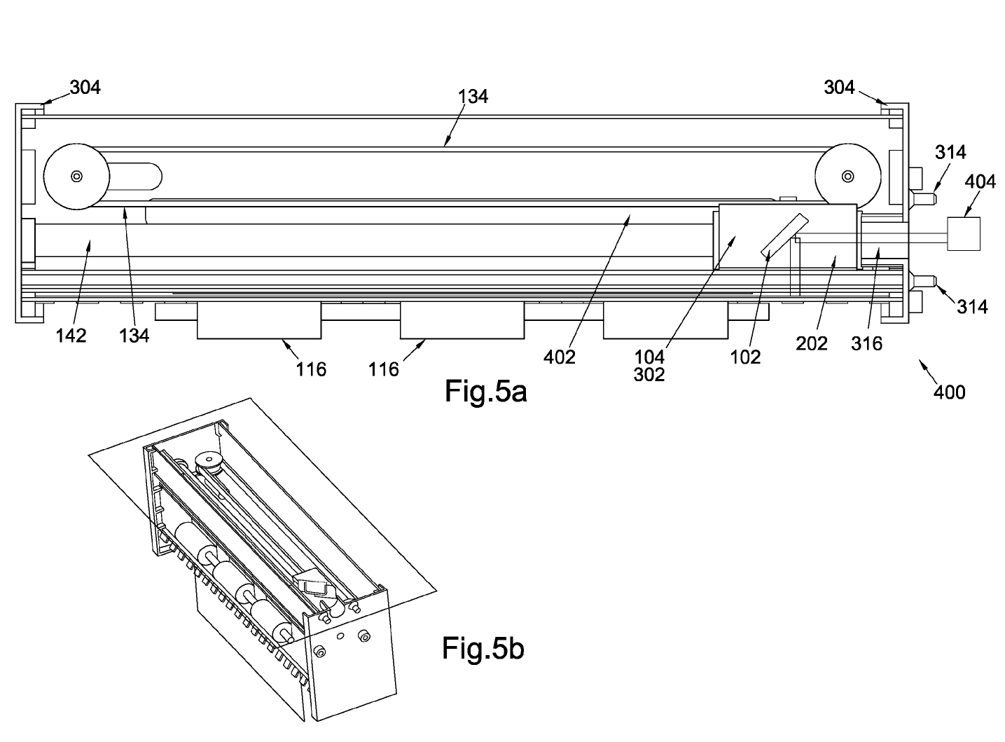

FIG. 5a shows a schematic, cross-sectional front view of an unprinter module 400. FIG. 5b shows the corresponding, schematic perspective view of the module 400.

In this example, the laser light beam generated by the laser light source 404 is reflected by the mirror 102 such that it impinges on the paper 112 at a 90 degree angle. An air inlet 402 is provided in the unprinter module 400 allowing air to be sucked into the module 400 to generate an air flow to extract the removed print debris. An additional filter may be provided on an inner or outer side of the air inlet 402 to avoid sucking dust from an environment of the unprinter into the unprinter module 400.

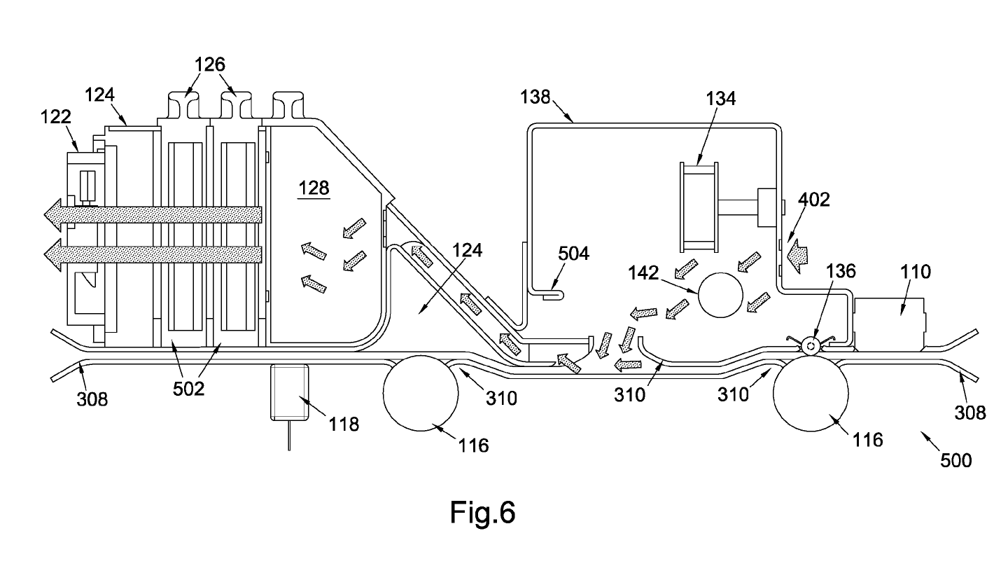

FIG. 6 shows a schematic, cross-sectional side-view of an air-flow path in an unprinter module 500 according to embodiments described herein. The air-flow path, which is indicated as yellow (bright) arrows (and black arrows in the debris chamber 128), is generated by fan 122.

Air may enter the unprinter module 500 via air inlet 402. The air-flow then collects removed print debris removed from the paper and provides it via an extraction system to the debris chamber 128. The majority of the removed print debris may be collected in the debris chamber 128. However, the air-flow transports fine particles, e.g. nano-particles via the debris chamber 128 to the filters 126. Once the air has been filtered by the debris chamber 128 and the filters 126, it can exit the unprinter module 500 via fan 122.

It is to be noted that in FIG. 6, various elements have been omitted for simplification, in particular features arranged in the cowl 138, such as the mirror 102 and the carrier 104. Guide rail 504 is provided to guide the rail runner 140. Cartridge slots 502 are provided in the unprinter module 500 for receiving filters 126.

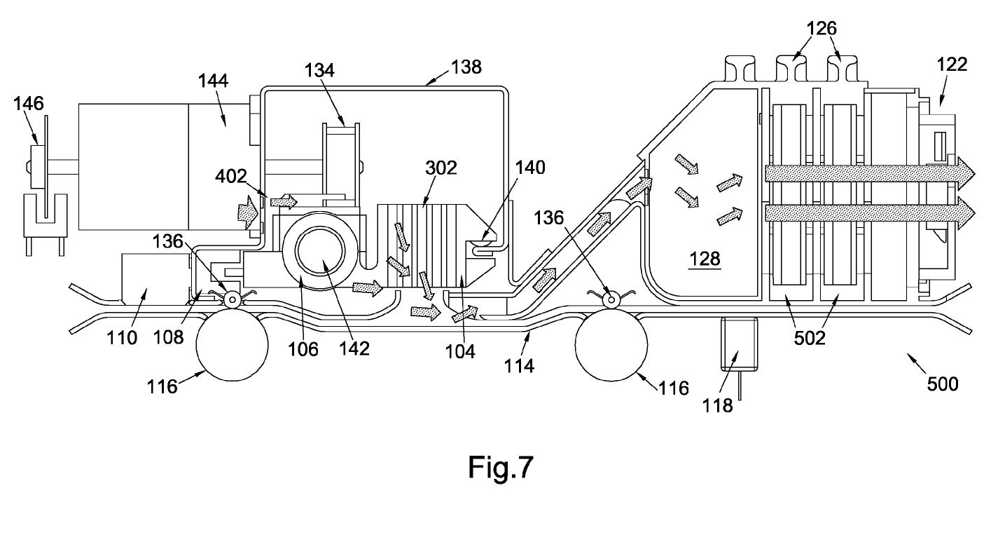

FIG. 7 shows the unprinter module 500 of FIG. 6 from the opposite side.

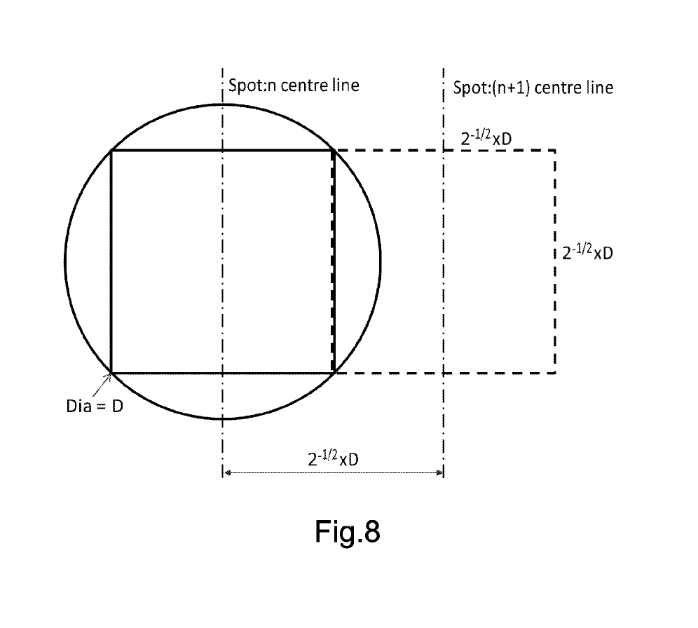

FIG. 8 shows a schematic of a spot size illustration of a laser light beam according to embodiments described herein.

It will be appreciated that the laser light beam may be operated continuously while the location of the mirror 102 is changed to expose different areas of the paper 112 to the laser light beam. However, preferably, the laser light beam is operated in pulses to only expose areas of the paper 112 on which print has been detected. The laser spot of a pulse n is indicated in FIG. 8 as a solid-line circle with a diameter D. As outlined above, the optimum separation between pulse n and an adjacent, subsequent pulse n+1 (that is the distance between the centres of the circles of pulse n and n+1, respectively) for speed of unprinting the whole paper is around 2^{-½}×D. In some embodiments described herein, the laser spot has a diameter of D>0.2 mm.

FIG. 9 shows distortion of a laser light beam using a mirror with a convex, concave, curved or other complex form, or a flat mirror which is titled such that the laser light beam impinges on the paper 112 at an angle smaller than 90 degrees. The arrow “A” indicates a direction of movement of the paper 112 in the unprinter. As outlined above, it may be preferable to distort the laser light beam such that it is longer in a direction of paper movement (direction “A”) than in a direction perpendicular thereto. Therefore, mechanical alignment in the direction of “A” may be less demanding in order to allow abutting or overlapping of adjacent swathes. A laser spot with an original diameter of, e.g. about D=1 mm may be distorted to be 4-5 mm long in the direction of paper movement (direction “A”) when it impinges on the paper 112.

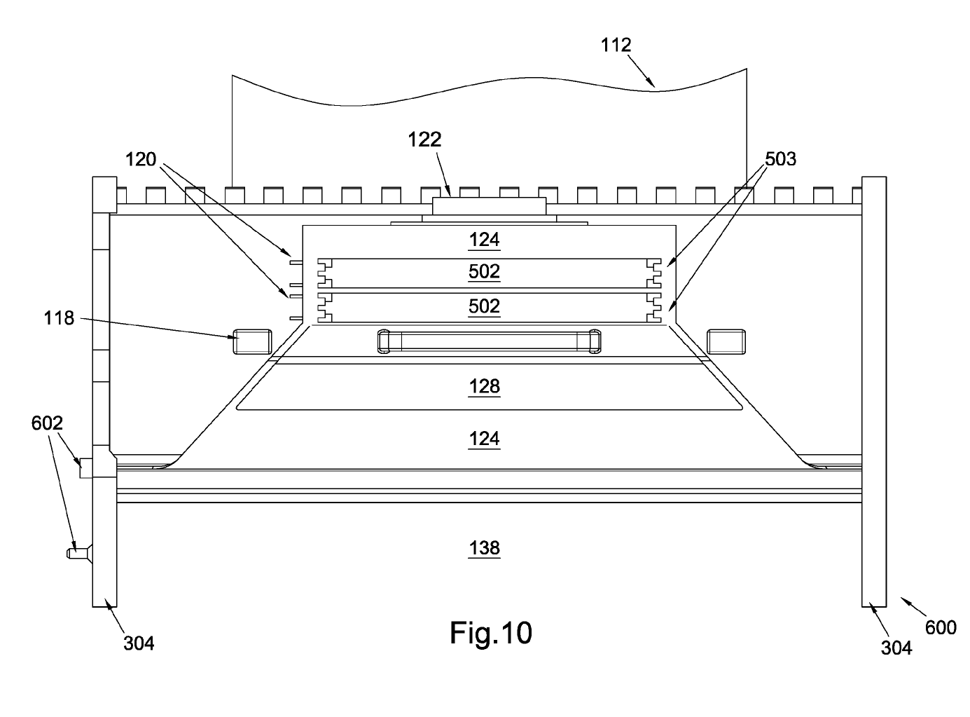

FIG. 10 shows a schematic top-view of cartridge slots 502 in an unprinter module 600 according to embodiments of the unprinter.

As can be seen from FIG. 10, in this example, the two cartridge slots 502 have dissimilar vertical guides 503 which are positioned at different locations on each of the slots 502. This may allow for ensuring that the correct cartridge is inserted into each of the slots, as the mating feature on the cartridge has to match that of the slot for it to be able to be inserted.

In this example, slot mating features are provided on both sides of the slots 502. It will be appreciated that one or more slot mating features may be provided on one side only, on both sides (as shown in FIG. 10), on three sides, on fourth sides, and alternatively or additionally on the bottom side of the manifold 124 of the unprinter module 600.

The filter detection opto-couplers 120 detect when a cartridge has been inserted into one of the slots 502. Even though only one filter detection opto-coupler is shown in FIG. 10 for each of slots 502, it will be appreciated that a plurality of opto-couplers or other switch types such as micro switches may be used for each slot 502.

In this example, the unprinter module 600 further comprises location features 602 for module alignment.

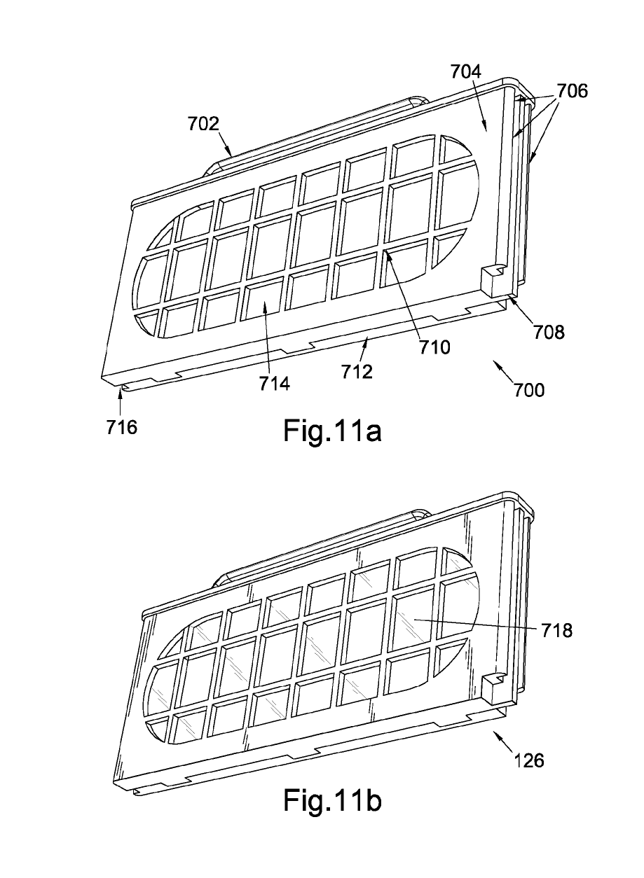

FIG. 11a shows a schematic, perspective view of a wireframe of a cartridge 700 configured to carry a filter material.

In order to simplify putting the cartridge 700 into and out of a slot 502 of the print removal system, the cartridge 700 has a cartridge handle 702. Other features may alternatively or additionally be provided on the cartridge 700 to aid removal and handling with or without a tool.

The cartridge 700 has a first cartridge case part 712 and a second cartridge case part 704 which are configured to host a filter material.

A filter retaining grill 710 is provided with windows 714 which allow for air to penetrate the cartridge 700, thereby enabling the filtering of removed print debris in the filter material.

The cartridge 700 further comprises a guide 716 which serves as a cartridge mating feature which is configured to interface with a slot mating feature of a slot 502 of the print removal system.

A detection flag 708 is provided on the cartridge 700 which allows for the filter detection opto-coupler 120 to detect the presence of the cartridge 700.

Further supplementary guide features 706 are arranged on the cartridge 700 for guiding the cartridge 700 into a slot 502 of the print removal system.

FIG. 11b shows a schematic, perspective view of a filter unit 126 as described above. The filter unit 126 comprises the cartridge 700 and a filter material 718 which is configured to filter removed print debris.

The cartridge parts may preferably be formed using low cost injection moulded parts. The cartridge parts may be assembled using screws and bosses, preferably formed in the plastic parts or a combination of clips, pins and screws may be exploited.

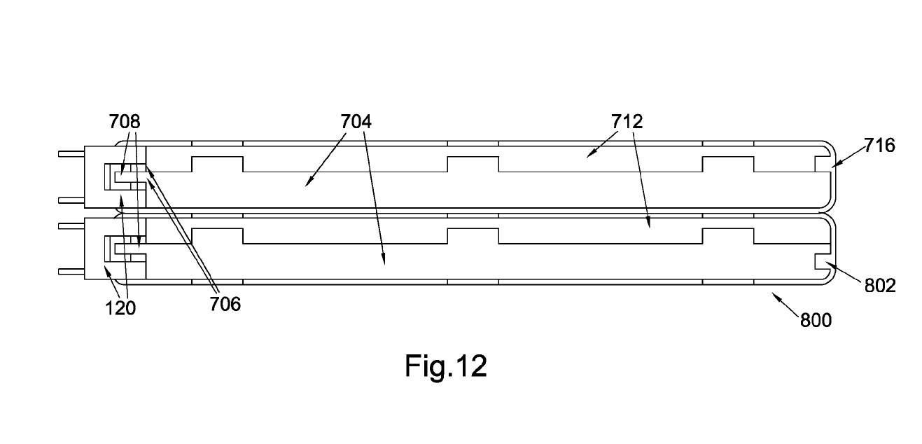

FIG. 12 shows a schematic, bottom view of filter cartridges 800.

In this example, a first cartridge 800 shows a first guide 716 as a mating feature which may interface with a slot mating feature of a slot 502. A second cartridge 800 has a mating feature 802 which is at a different location on the cartridge 802 compared to the mating feature 716 on the first cartridge 800. As outlined above, this allows for ensuring that the correct cartridge is to be inserted into a slot 502.

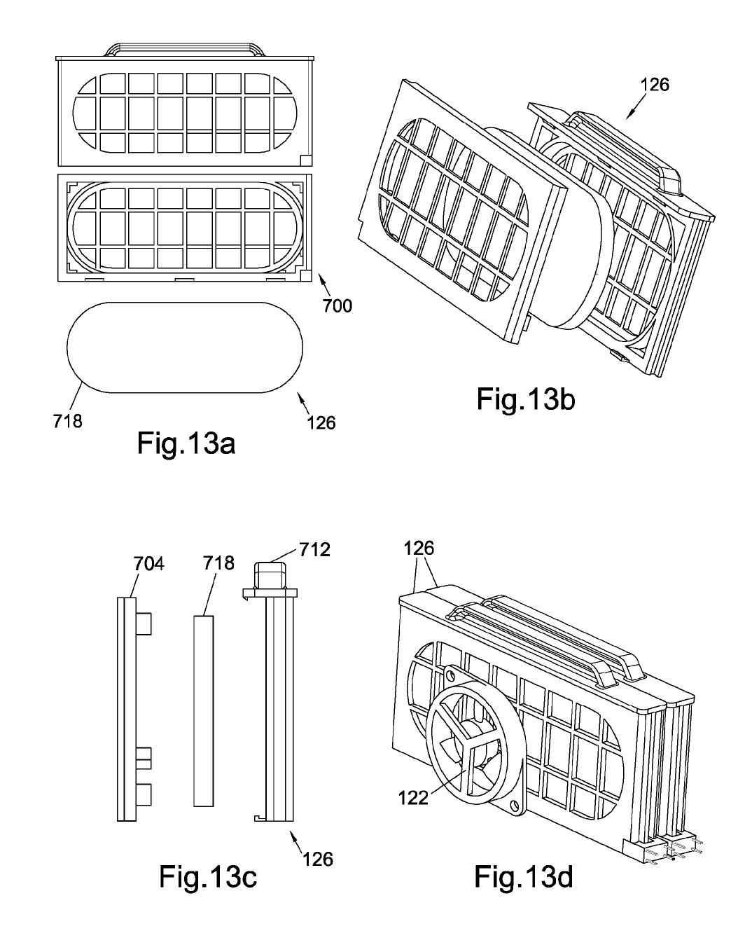

FIGS. 13a and 13b show schematics of a filter unit 126 in an exploded view. As can be seen, the cartridge frame 700 may be opened in order to replace the filter material 718. In some embodiments, the cartridge frame 700 may not be opened by the user and the filter unit 126 may need to be replaced entirely, if necessary. This may be preferable as the user may not be exposed to removed print debris collected on the filter material 718 and the user is prevented from inserting an incorrect filter material.

FIG. 13c shows a schematic side-view of an opened filter unit 126. The first cartridge case part 712 and the second cartridge case part 704 have been separated, for example prior to assembly of the filter unit 126, or thereafter, thereby allowing replacement of a used or clogged filter material 718.

As outlined above, the cartridge frame 700 may comprise more than two parts. Preferably the first cartridge cage part 712 is the same for all cartridge options and the second cartridge cage part 704 is selectable having a portion to exclude the possibility of inserting a given type into an incorrect slot 502. It will be appreciated that, alternatively, the second cartridge cage part 704 is the same for all cartridge options, while the first cartridge cage part 712 is selectable.

FIG. 13d displays a schematic, perspective view showing relative positions in an embodiment of filter units 126 with a fan 122 of the print removal system. As outlined above, the filter units 126 are preferably arranged in front of the fan 122 in the air-flow direction such that the filter units 126 filter out any removed print debris, allowing for the fan 122 to run in clean air.

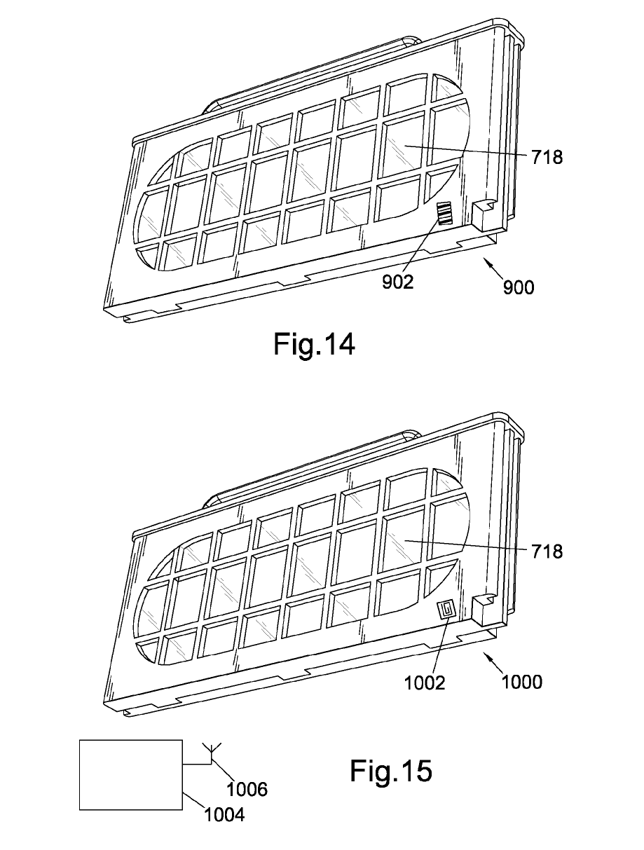

FIG. 14 shows a schematic of a filter unit 900 with a cartridge having a barcode 902. As outlined above, this may allow for obtaining information about a type or model of a cartridge and/or information about a usage of a cartridge, and/or information about a print removal system in which a cartridge has previously been used (an external database may be exploited for storing data relating to unprinters in which the filter may have been used previously). A message may be signalled to the user by the print removal system, specifying the information obtained via the barcode. The information may further be used to signal a warning to the user if the cartridge is not compatible with the print removal system, and/or if the cartridge should not be used as it is clogged or malfunctioning, which may have been determined previously.

FIG. 15 shows a schematic of a filter unit 1000 and a print removal system 1004. The filter unit 1000 comprises a cartridge having an electronic tag 1002. It will be appreciated that the electronic tag 1002 may be arranged at any location inside or on the filter unit 1000.

The print removal system 1004 comprises a tag reader 1006 which is configured to read, and optionally to write, the electronic tag 1002 of the filter unit 1000. This allows the print removal system 1004 to obtain information about a type or model of the filter unit 1000, and/or about a usage of the filter unit 1000, and/or about the print removal system in which the filter unit 1000 has previously been used. This information may then be used to determine, for example, whether a specific filter, which may be arranged in the cartridge, is inserted into the correct slot of the print removal system 1004, and/or whether the filter is new, partially used or clogged/full or malfunctioning (which may have been determined previously). It will be appreciated that the cartridge may have a processor and/or memory which may be used to store the above information about the filter unit 1000. Alternatively, the processor may be external to the cartridge which comprises a memory which may be accessed to obtain information about the filter unit 1000.

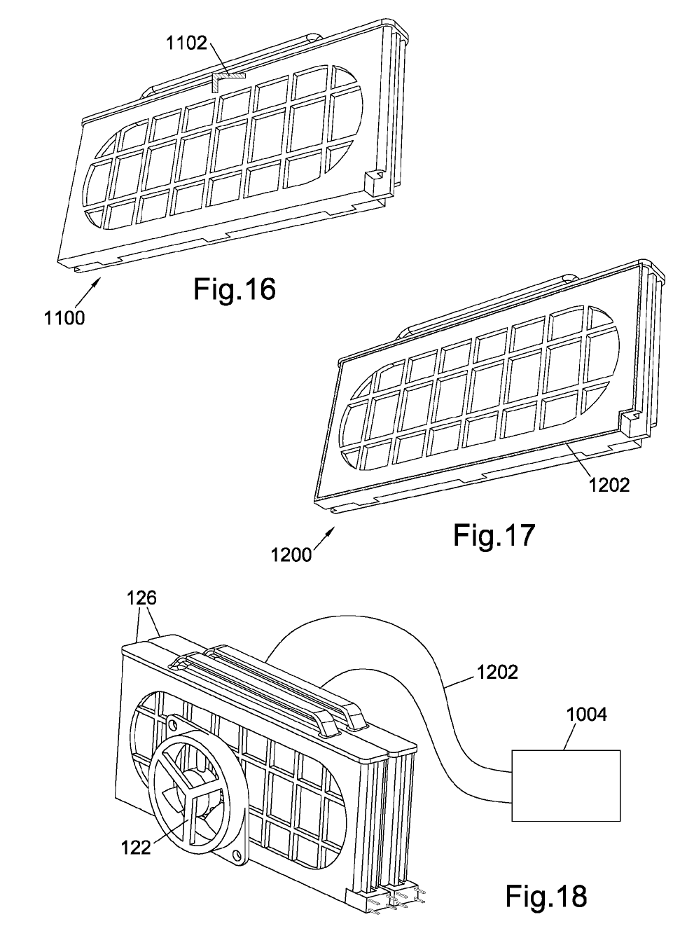

FIG. 16 shows a schematic of a filter unit 1100, whereby the cartridge has a clip 1102. The clip 1102 is configured to connect the filter unit 1100 to a second filter unit having a corresponding receiving part for the clip 1102. As the clip may have a specific shape and/or size, it allows only specific filter units 1100 to be connected to each other.

FIG. 17 shows a schematic of a filter unit 1200, whereby the cartridge has a seal 1202. The seal 1202 is configured to engage with one or both of a seal of a second cartridge and a slot 502 of the print removal system, so as to seal an exhaust channel of the print removal system. This advantageously allows ensuring that no removed print debris may exit the print removal system which may otherwise cause detriment to the equipment, environment or user of the system.

FIG. 18 shows a schematic of a print removal system, whereby the print removal device 1004 is separated from the filter units 126. The print removal device is configured to remove print from a print-carrying medium. The removed print debris is then sucked by the fan 122 towards the filter units 126 via the exhaust channel 1202.

In this example, the fan 122 sucks air to transport removed print debris to the filter units 126. It will be appreciated that alternatively, a fan may be provided at the print removal device 1004 which blows air towards the filter units 126. However, this may result in print debris exiting the print removal system from potential leaks. By sucking air (as shown in FIG. 18), merely clean air from the outside of the system may enter the system through leaks and no print debris can exit the system via those leaks, which is therefore the preferred option.

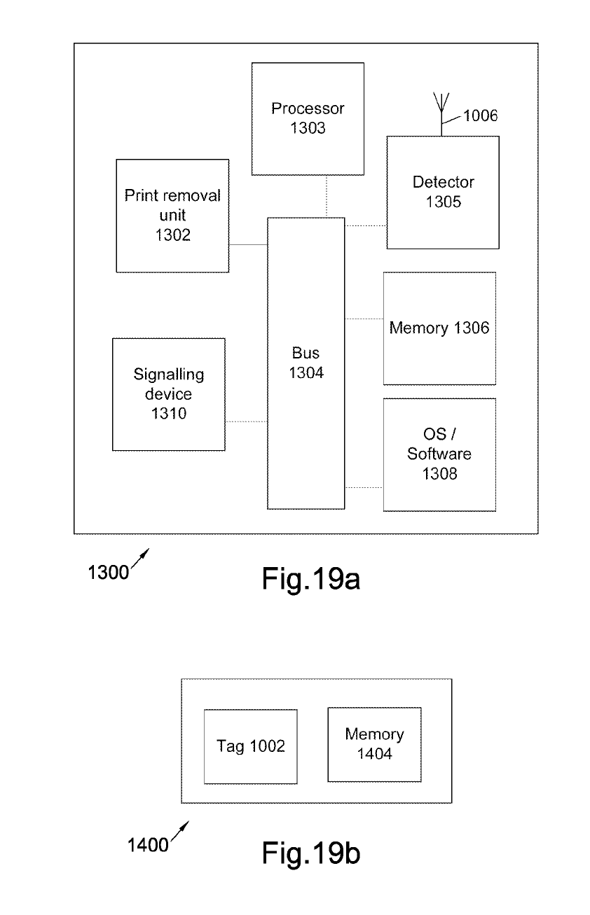

FIGS. 19a and 19b show a schematic representation of a print removal system 1300 and a filter unit 1400, respectively.

The print removal system 1300 comprises a print removal device 1302 with slots 502 (not shown). As outlined above, once a barcode 902 or electronic tag 1002 of a filter unit 1400 (cartridge with a filter material) has been detected by the detector 1305 of the print removal system 1300, the system 1300 can obtain information about the type or model of filter unit 1400, and/or information about the usage of the filter unit 1400. This information may have been stored in memory 1404 of the filter unit 1400. Where a barcode 902 is used, this information may similarly be encoded in the barcode 902 or the barcode date may be used as an index to a remote database holding other data.

As outlined above, the detector may be a tag reader with an antenna 1006, or it may be an optical sensor for reading a barcode 902.

The above information about the filter unit 1400 is processed by processor 1303 of the print removal system 1300 which is connected to the other units of the print removal system 1300 via bus 1304. Information about the filter unit 1400 may be stored in memory 1306.

The print removal system further comprises an OS/software 1308 (stored in an internal memory of the print removal system 1300, which may be integral to memory 1306).

Depending on the information provided by the filter unit 1400 to the print removal system 1300, the information is processed and may be provided to a signalling device 1310. The signalling device 1310 may then indicate to the user (for example optically and/or acoustically) that the filter unit 1400 is compatible with the slot 502 into which the user is about to insert (or has inserted) the filter unit 1400. Signalling device 1310 may also signal to the user whether the filter unit 1400 is clogged such that operation with the current filter unit 1400 may be prevented. Signalling device 1310 may also exchange and maintain data on a remote database.

No doubt many other effective alternatives will occur to the skilled person. For example, the cartridge filter units may be clipped over the exhaust port from the fan, i.e. outside of the cowl rather than inserted into a slot. It will be understood that the invention is not limited to the described embodiments and encompasses modifications apparent to those skilled in the art and lying within the spirit and scope of the claims appended hereto.

1. A print removal system for removing print from a print-carrying medium, the print removal system comprising:
a print removal device for removing said print from said print-carrying medium;
a fan configured to generate an air-flow in said print removal system for extracting said removed print debris from an area of said print removal system at which said print has been removed from said print-carrying medium;
one or more slots arranged on a side of said fan facing towards said area, wherein said one or more slots are separated from said print removal device and connected to said print removal device via an air-flow channel; and
at least one cartridge configured to collect removed print debris, wherein the cartridge is configured to be inserted into a corresponding slot of the one or more slots.

2. A print removal system as claimed in claim 1, further comprising an extraction system comprising an exhaust channel for extracting said removed print debris, wherein said one or more slots intersect said exhaust channel.

3. A print removal system as claimed in claim 1, further comprising a detector for detecting when a said cartridge has been inserted into a said slot.

4. A print removal system as claimed in claim 3, wherein said detector comprises one or more switches configured to switch when a said cartridge has been inserted into a said slot.

5. (canceled)

6. A print removal system as claimed in claim 3, comprising an electronic tag configured to be read by the detector and to provide information to said print removal system about at least one of: a type or model of said cartridge, a usage of said cartridge, and a print removal system in which said cartridge has previously been used, wherein said detector comprises one or more tag readers configured to detect a tag of said cartridge.

7. A print removal system as claimed in claim 6, further comprising a processor and a memory, wherein said tag reader is configured to receive information from said tag about a type or model of said cartridge and/or information about a usage of said cartridge and/or information about said print removal system in which said cartridge has previously been used, and wherein said received information is processed by said processor and stored in said memory.

8. (canceled)

9. A print removal system as claimed in claim 3, wherein said detector is configured to detect a barcode on a said cartridge, the cartridge comprising a barcode configured to be read by the detector and to provide information to said print removal system about at least one of: a type or model of said cartridge, a usage of said cartridge, and a print removal system in which said cartridge has previously been used.

10. A print removal system as claimed in claim 1, wherein said slot comprises a slot mating feature for interfacing with a cartridge mating feature on said cartridge for ensuring that a correct cartridge is inserted into said slot and/or that said cartridge is inserted into a said slot in a correct orientation.

11. A print removal system as claimed in claim 10, wherein said slot mating feature is formed of a rib configured to penetrate said cartridge mating feature.

12. A print removal system as claimed in claim 10, wherein said slot mating feature is a rib projection configured to receive said cartridge mating feature in the form of a rib on a said cartridge.

13. A print removal system as claimed in claim 10, wherein a first slot comprises a first slot mating feature which is different from a second slot mating feature of a second slot.

14. A print removal system as claimed in claim 1, wherein at least two of said slots comprise different shapes and/or sizes.

15-17. (canceled)

18. A print removal system as claimed in claim 1, wherein the cartridge comprises one or both of a collection chamber and one or more filters for collecting removed print debris.

19-21. (canceled)

22. A print removal system as claimed in claim 1, wherein the cartridge comprises a connector configured to connect said cartridge to a second said cartridge, and wherein said connector has a shape or size which allow only specific cartridges to be connected to each other.

23. A print removal system as claimed in claim 1, wherein the cartridge comprises a grid configured to retain a filter material and to allow air to penetrate said filter material.

24. A print removal system as claimed in claim 23, wherein said grid comprises members for redirecting an air-flow within said cartridge.

25. A print removal system as claimed in claim 1, wherein the cartridge comprises a seal configured to engage with one or both of a second seal of a second cartridge and said slot of said print removal system, so as to seal an exhaust channel of said print removal system.

26. A print removal system as claimed in claim 1, comprising a filter unit comprising the cartridge and a filter configured to filter print debris removed from a print-carrying medium with a print removal system.

27. An unprinter filter cartridge, the filter cartridge comprising one or more of:
an identifier readable by a mating unprinter to identify a type of the filter cartridge;
a communication device to cooperate with a reader of the unprinter to communicate an identity or characteristic of the filter cartridge, in particular a measure of a remaining operational life of the filter cartridge;
a mechanical interface to selectively interface with a second filter cartridge to ensure multiple cartridges fitted within said unprinter are of defined types and/or have a defined sequence with respect to an air-flow within the unprinter;
a seal to cooperate with a second filter cartridge to ensure multiple cartridges fitted within said unprinter define a mutual seal to define an air-flow through the cartridges;
a mechanical slot to, when fitted, receive a projection of said unprinter to define an orientation of the cartridge within the unprinter.

28. An unprinter fitted with one or more filter cartridges as recited in claim 27.
